(19) United States
(12) Patent Application Publication
(10) Pub. No.: US 2005/0091279 A1
(43) Pub. Date: Apr. 28, 2005

(54) Use of transform technology in construction of semantic descriptions

(76) Inventor: Hawley K. Rising III, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/953,194

(22) Filed: Sep. 28, 2004

Related U.S. Application Data
(60) Provisional application No. 60/506,931, filed on Sep. 29, 2003.

(51) Int. Cl. G06F 7/00

(52) U.S. Cl. 707/104.1

(57) ABSTRACT

Existing descriptions are blended to create a new description, and a residue is extracted from each of the plurality of existing descriptions. Further, a set of image style pyramids is created for the new description using residues extracted from the existing descriptions.

### RELATED APPLICATIONS

This application is related to and claims the benefit of U.S. Provisional Patent application Ser. No. 60/506,931 filed Sep. 29, 2003, which is hereby incorporated by reference.

### FIELD OF THE INVENTION

This invention relates generally to the description of multimedia content, and more particularly to constructing semantic descriptions using transform technology.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © 2001, Sony Electronics, Inc., All Rights Reserved.

### BACKGROUND OF THE INVENTION

Digital multimedia information is becoming widely distributed through broadcast transmission, such as digital television signals, and interactive transmission, such as the Internet. The information may be in still images, audio feeds, or video data streams. However, the availability of such a large volume of information has led to difficulties in identifying content that is of particular interest to a user. Various organizations have attempted to deal with the problem by providing a description of the information that can be used to search, filter and/or browse to locate the particular content. The Moving Picture Experts Group (MPEG) has promulgated a Multimedia Content Description Interface standard, commonly referred to as MPEG-7 to standardize the content descriptions for multimedia information. In contrast to preceding MPEG standards such as MPEG-1 and MPEG-2, which define coded representations of audio-visual content, an MPEG-7 content description describes the structure and semantics of the content and not the content itself.

Using a movie as an example, a corresponding MPEG-7 content description would contain “descriptors,” which are components that describe the features of the movie, such as scenes, titles for scenes, shots within scenes, and time, color, shape, motion, and audio information for the shots. The content description would also contain one or more “description schemes,” which are components that describe relationships among two or more descriptors, such as a shot description scheme that relates together the features of a shot. A description scheme can also describe the relationship among other description schemes, and between description schemes and descriptors, such as a scene description scheme that relates the different shots in a scene, and relates the title feature of the scene to the shots.

MPEP-7 uses a Data Definition Language (DDL) to define descriptors and description schemes, and provides a core set of descriptors and description schemes. The DDL definitions for a set of descriptors and description schemes are organized into “schemas” for different classes of content. The DDL definition for each descriptor in a schema specifies the syntax and semantics of the corresponding feature. The DDL definition for each description scheme in a schema specifies the structure and semantics of the relationships among its children components, the descriptors and description schemes. The DDL may be used to modify and extend the existing description schemes and create new description schemes and descriptors.

The MPEG-7 DDL is based on the XML (extensible markup language) and the XML Schema standards. The descriptors, description schemes, semantics, syntax, and structures are represented with XML elements and XML attributes. Some of the XML elements and attributes may be optional.

The MPEG-7 content description for a particular piece of content is an instance of an MPEG-7 schema; that is, it contains data that adheres to the syntax and semantics defined in the schema. The content description is encoded in an “instance document” that references the appropriate schema. The instance document contains a set of “descriptor values” for the required elements and attributes defined in the schema, and for any necessary optional elements and/or attributes. For example, some of the descriptor values for a particular movie might specify that the movie has three scenes, with scene one having six shots, scene two having five shots, and scene three having ten shots. The instance document may be encoded in a textual format using XML, or in a binary format, such as the binary format specified for MPEG-7 data, known as “BiM,” or a mixture of the two formats.

The instance document is transmitted through a communication channel, such as a computer network, to another system that uses the content description data contained in the instance document to search, filter and/or browse the corresponding content data stream. Typically, the instance document is compressed for faster transmission. An encoder component may both encode and compress the instance document or the functions may be performed by different components. Furthermore, the instance document may be generated by one system and subsequently transmitted by a different system. A corresponding decoder component at the receiving system uses the referenced schema to decode the instance document. The schema may be transmitted to the decoder separately from the instance document, as part of the same transmission, or obtained by the receiving system from another source. Alternatively, certain schemas may be incorporated into the decoder.

Description schemes directed to describing content generally relate to either the structure or the semantics of the content. Structure-based description schemes are typically defined in terms of segments that represent physical, spatial and/or temporal features of the content, such as regions, scenes, shots, and the relationships among them. The details of the segments are typically described in terms of signals, e.g., color, texture, shape, motion, etc.

The semantic description of the content is provided by the semantic-based description schemes. These description schemes describe the content in terms of what it depicts, such as objects, people, events, and their relationships. Depending on user domains and applications, the content can be described using different types of features, tuned to the area of application. For example, the content can be described at a low abstraction level using descriptions of such content features as objects' shapes, sizes, textures, colors, movements and positions. At a higher abstraction level, a description scheme may provide conceptual information about the reality captured by the content such as information about objects and events and interactions among objects. For example, a high abstraction level description may provide the following semantic information: “This is a scene with a barking brown dog on the left and a blue ball that falls down on the right, with the sound of passing cars in the background.”

Current methods for constructing semantic descriptions allow for automatic creation of simple, low-level descriptions. However, human descriptions are often referential and metaphorical. Hence, the above methods cannot be used for semantic descriptions resembling more complex human descriptions.

### SUMMARY OF THE INVENTION

Existing descriptions are blended to create a new description, and a residue is extracted from each of the plurality of existing descriptions. Further, a set of image style pyramids is created for the new description using residues extracted from the existing descriptions.

### BRIEF DESCRIPTION OF THE DRAWINGS

FIG. 1 illustrates one embodiment of a multimedia content description system.

FIGS. 2 and 3 illustrate prior art embodiments for creating mental spaces.

FIGS. 4 and 5 illustrate processes performed by a server according to some embodiments of the present invention.

FIGS. 6A-6C illustrate the operation of a process for blending descriptions, according to one embodiment of the present invention; and

FIG. 7 is a block diagram of an exemplary computer system.

### DETAILED DESCRIPTION OF THE INVENTION

In the following detailed description of embodiments of the invention, reference is made to the accompanying drawings in which like references indicate similar elements, and in which is shown, by way of illustration, specific embodiments in which the invention may be practiced. These embodiments are described in sufficient detail to enable those skilled in the art to practice the invention, and it is to be understood that other embodiments may be utilized and that logical, mechanical, electrical, functional and other changes may be made without departing from the scope of the present invention. The following detailed description is, therefore, not to be taken in a limiting sense, and the scope of the present invention is defined only by the appended claims.

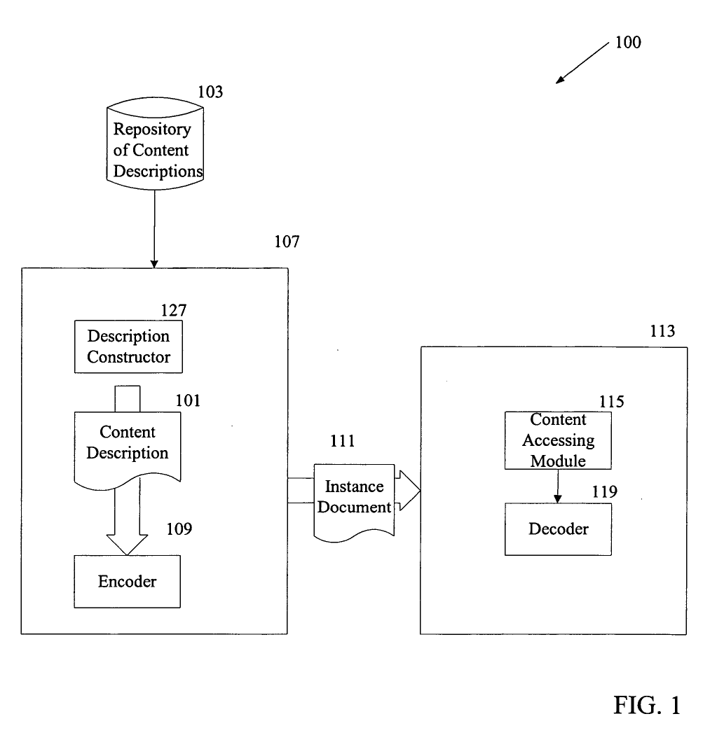

Beginning with an overview of the operation of the invention, FIG. 1 illustrates one embodiment of a multimedia content description system 100. A new content description 101 is created by a description constructor 127 on a server 107. The description constructor 127 creates the new content description 101 from one or more existing descriptions stored in a repository 103 of content descriptions. The content description 101 is encoded into an instance document 111 using an encoder 109 on the server 107. The instance document 111 is transmitted by the server 107 to a client system 113.

The client system 113 includes a content accessing module 115 that uses the content description 101 to search, filter and/or browse the corresponding content data stream. The content accessing module 115 may employ a decoder 119 to obtain the structure and semantic information about the content using the instance document 111.

In one embodiment, the description constructor 127 creates a set of image style pyramids for the new content description 101. The set of image style pyramids may include, for example, a Gaussian pyramid, a Laplacian pyramid, and a wavelet pyramid. The encoder 109 then transmits the image style pyramids of the new description to the client 113. In one embodiment, the repository 103 stores image style pyramids of semantic descriptions to facilitate efficient construction of new descriptions. In addition, the image style pyramids may be used for analysis of the semantic descriptions or any other processing of the semantic descriptions. Subject to restrictions governing data loss, the image style pyramids may be decoded to recover the original descriptions.

In one embodiment, the new description is an MPEG-7 description scheme (DS) pertaining to semantic aspects of the content. Each semantic description may be represented as a graph, with nodes deriving from the SemanticBase DS and edges being semantic relations selected from a list of conforming relations from semantic objects. In particular, graphical classification schemes (GCS) may be used to store templates of descriptions that may be reused and graph transformation steps that may be reused. Graph transformations may include, for example, a pushout such as a single pushout known as a pasting operation or a double pushout known as a cut and paste operation, and a pullback such as a single pullback known as a node replacement or a double pullback known as a replace operation for complex parts. Depending on the area of content, a description may belong to a certain application domain representing a grammar with respect to templates and transformation in the GCS. The grammar may be used to partition a description. That is, factoring a description by templates or by several distinct grammars in the GCS may be used to break down a description.

In one embodiment, the description constructor 127 constructs new semantic descriptions using a process that resembles a mental space model. Mental spaces provide context for communication by importing a lot of information not included in the speech, thereby providing a mechanism for interpreting semantic content in language. This information is imported using maps. These maps function by using (i.e., “recruiting”) frames which represent predefined constructs for interpretation, projecting structure from one mental space to another, and integrating or abstracting imported material from more than one other mental space. Accordingly, each mental space may represent an extended description containing entities, relationships, and frames. Several mental spaces may be active at once, in order to properly define all the entities in the description. These mental spaces enter into relationships with each other. Because the mental spaces borrow structure and entities from each other, mappings are necessary between these mental spaces. The whole composite forms a backdrop to the expressed description and completes the process of attaching semantic meaning to the entities involved.

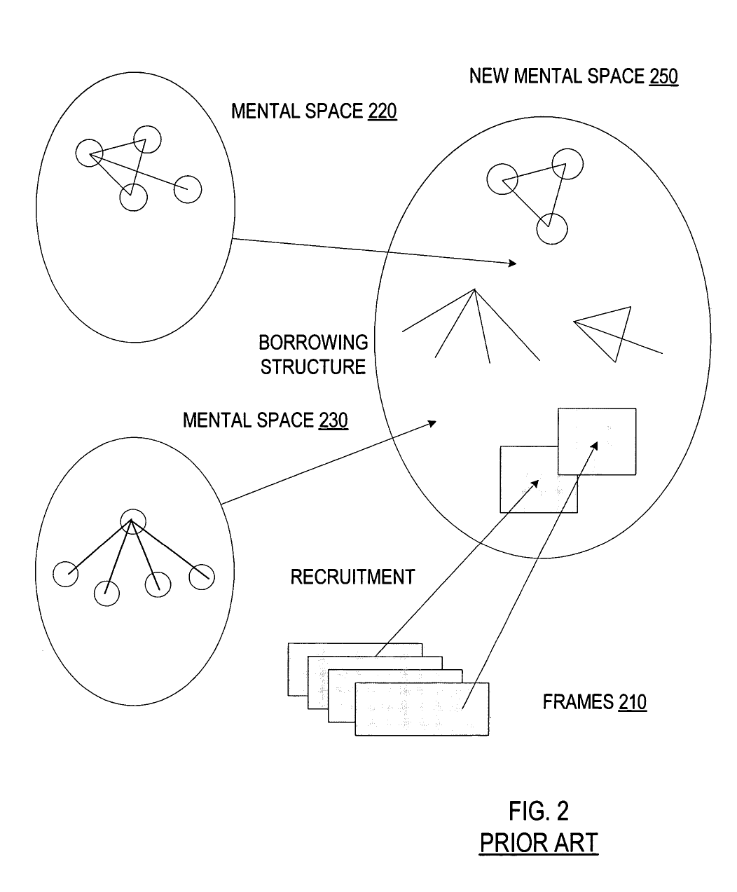

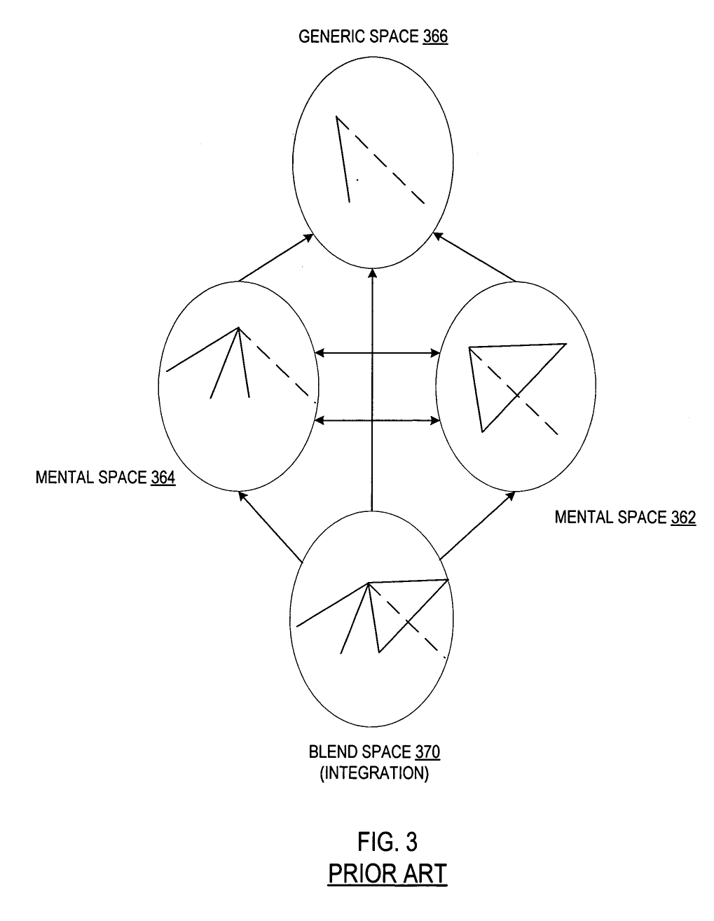

FIGS. 2 and 3 illustrate prior art embodiments for creating mental spaces. Referring to FIG. 2, a new mental space 250 is created by recruiting some of frames 210 and borrowing structures from existing mental spaces 220 and 230. The structures may include elements (e.g., objects, events, places, etc.), subspaces that may be formed by compressing existing spaces based on predefined rules or created as aggregates co-activated in a contextually dependent manner.

Referring to FIG. 3, a new mental space 370 is created by blending or integrating two existing mental spaces 362 and 364. A generic space 366 may then be created by abstracting from all three mental spaces: new mental space 370 and existing mental spaces 364 and 362. A generic space 366 includes structures that are common to the mental spaces 362, 364 and 370.

The MPEG-7 model allows mental spaces that include, for example, basic descriptions created for a current description, template elements allowing for validation and recruitment, production steps to provide the process (“run the space”), production steps and ontology links to allow interpretation and recruitment, and basic elements that are graphs and productions. In addition, the MPEG-7 model allows for blending. Results of the blend may be expressed as a selective projection (restriction of the pushout maps that can be done by restricting to subsets of the input set), composition (fusion in the iterative step), completion (recruitment from GCS that has been tapped to do the description), elaboration (tentative running of processes discovered by completion), and an emergent structure (recorded to add new entries to the GCS or to complete the description).

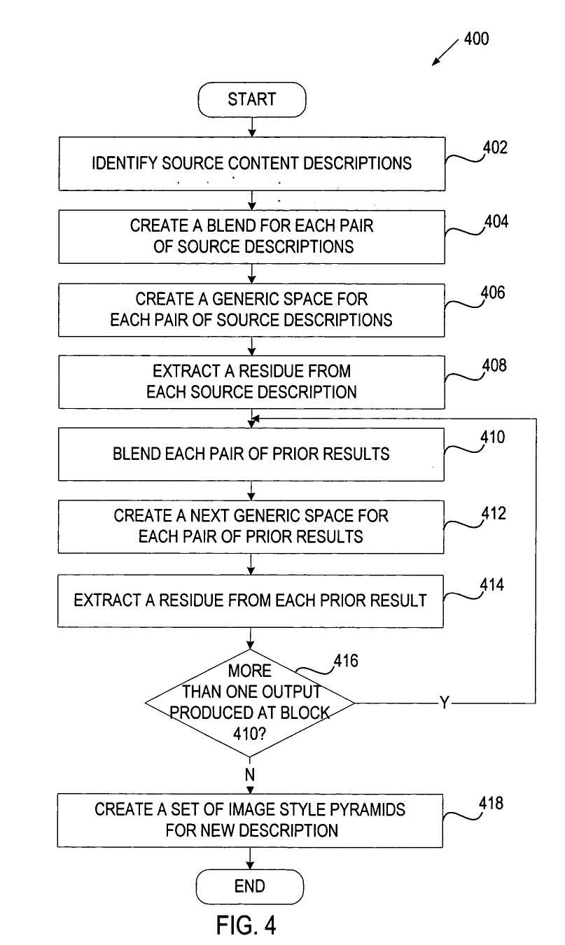

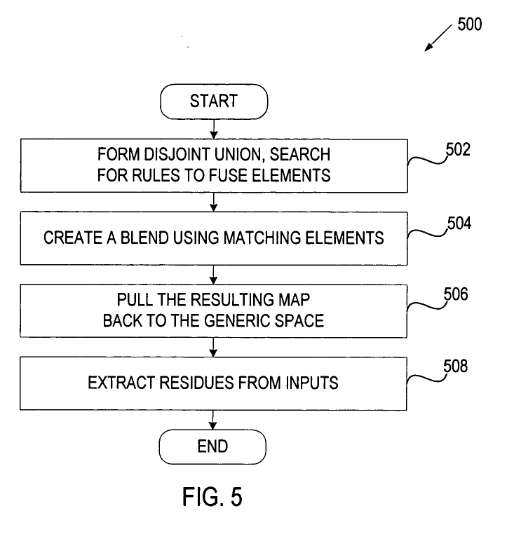

FIGS. 4 and 5 illustrate processes performed by the server 107 according to some embodiments of the present invention. The processes may be performed by processing logic that may comprise hardware (e.g., circuitry, dedicated logic, etc.), software (such as run on a general purpose computer system or a dedicated machine), or a combination of both. For a software-implemented process, the description of a flow diagram enables one skilled in the art to develop such programs including instructions to carry out the processes on suitably configured computers (the processor of the computer executing the instructions from computer-readable media, including memory). The computer-executable instructions may be written in a computer programming language or may be embodied in firmware logic. If written in a programming language conforming to a recognized standard, such instructions can be executed on a variety of hardware platforms and for interface to a variety of operating systems. In addition, the embodiments of the present invention are not described with reference to any particular programming language. It will be appreciated that a variety of programming languages may be used to implement the teachings described herein. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or produce a result. It will be appreciated that more or fewer operations may be incorporated into the processes illustrated in FIGS. 4 and 5 without departing from the scope of the invention and that no particular order is implied by the arrangement of blocks shown and described herein.

FIG. 4 is flow diagram of one embodiment of a process 400 for constructing a description.

Referring to FIG. 4, process 400 begins with processing logic identifying two or more content descriptions that can be used as a source of a new content description (processing block 402). The identification process may be performed upon receiving one or more elements associated with the new content description (e.g., an adjectival property of the entity being described, a relationship between this entity and another entity, the structure of the entity, etc.). Based on the received elements, processing logic may identify existing content descriptions that have common elements with the new content description. In one embodiment, the content descriptions are MPEG-7 description schemes (DSes) pertaining to semantic aspects of the content.

Next, processing logic blends the identified content descriptions together. In particular, processing logic creates a blend for each pair of the identified descriptions (processing block 404), creates a generic space for each pair of the identified descriptions (processing block 406), and extracts a residue from each of the input descriptions (processing block 408). Then, processing block blends each pair of the prior results (processing block 410), creates a next generic space for each pair of the prior results (processing block 412), and extracts a residue from each of the prior results (processing block 414). The operations of processing blocks 410 through 414 are preformed iteratively until processing block 410 produces a single output (processing box 416).

Further, processing logic creates a set of image style pyramids for the new description using the residues, resulting generic spaces, and/or resulting blends (processing block 418). The set of image style pyramids may include, for example, a wavelet pyramid, a Laplacian pyramid, and a Gaussian pyramid.

The creation of image style pyramids allows for analyses of descriptions, efficient transmission and storage of descriptions, and efficient construction of new descriptions.

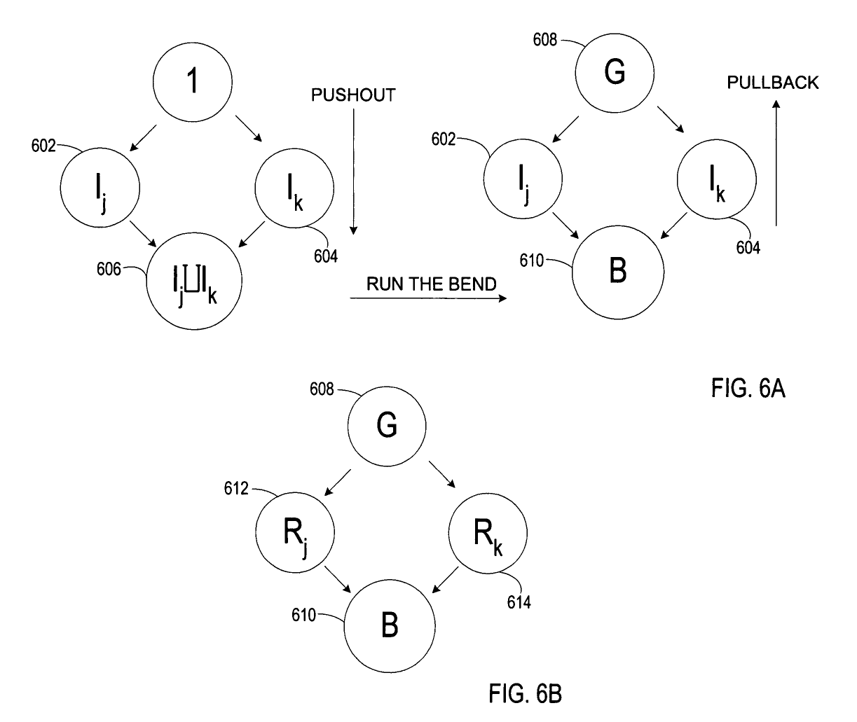

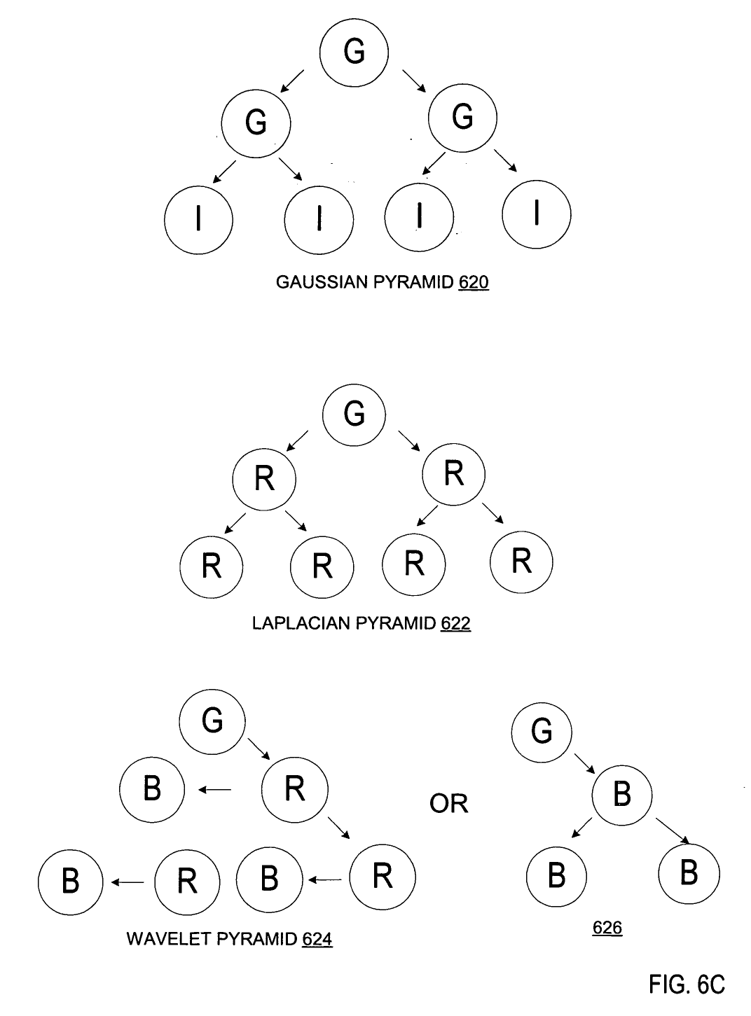

In one embodiment, depending on the rules for running the blend and the information saved in the wavelet pyramid, all the pyramids in the set can be used to reconstruct the original descriptions. If subtraction (cutting) of the generic space from the blended space results in two spaces, then the wavelet transform may be recoverable. Otherwise, the extra spaces may need to be saved, as will be discussed in greater detail below in conjunction with FIG. 6C.

In one embodiment, multiple image descriptions are encoded as a wavelet transform that includes a set of new image descriptions. Subsequently, the original image descriptions may be decoded from the wavelet transform in a lossless or lossy fashion depending on restrictions governing data loss.

FIG. 5 is flow diagram of one embodiment of a process 500 for blending source descriptions.

Referring to FIG. 5, process 500 begins with processing logic forming a disjoint union for the first pair of source descriptions and searching for rules to fuse elements of these source descriptions (processing block 502).

At processing block 504, processing logic creates a blend of these source descriptions based on their matching elements. The blend may be created by performing the pushout and then running the blend.

At processing block 506, processing logic creates a generic space for the source descriptions by pulling the resulting map back to the generic space.

At processing block 508, processing logic extracts a residue from each input source description.

If the source descriptions include more than two descriptions, process 500 is repeated for each additional pair of source descriptions, and then the results are blended in subsequent iterations until a single output is produced.

FIGS. 6A-6C illustrate the operation of process 500.

Referring to FIG. 6A, a disjoint union 606 is formed for two input descriptions 602 and 604. Then, the pushout is performed and the blend is run to create a blend space 610. Further, the pullback is performed to get to the generic space 608. If four source descriptions are used, and the blends are not shown, a sequence of generic space leads to a Guassian pyramid 620 illustrated in FIG. 6C.

The generic space 608 may be used to extract residues from the input descriptions 602 and 604. FIG. 6B illustrates the blend 610 expressed using residues 612 and 614. If four source descriptions are used, the sequence of generic space may lead to a Laplacian pyramid 622 illustrated in FIG. 6C.

Residues may also be derived from blends. Then, the sequence of generic space may lead to a wavelet pyramid 624 or 626 illustrated in FIG. 6C. If subtraction (cutting) of the generic space (G) from the blended space (B) results in two spaces, then the wavelet transform 626 is recoverable. Otherwise, the extra spaces (R) need to be saved as in the wavelet pyramid 624. The wavelet pyramid 626 may be used, for example, to create new descriptions and factoring hierarchies. Because each combination produces both a generic space and a blend, the creation of the pyramids may be started from anywhere in the pyramid (unlike wavelets in a signal processing setting).

The image style pyramids 620 through 624 have familiar image analysis and multimedia names and properties, allowing for analysis of descriptions, as well as their efficient storage, transmission and construction.

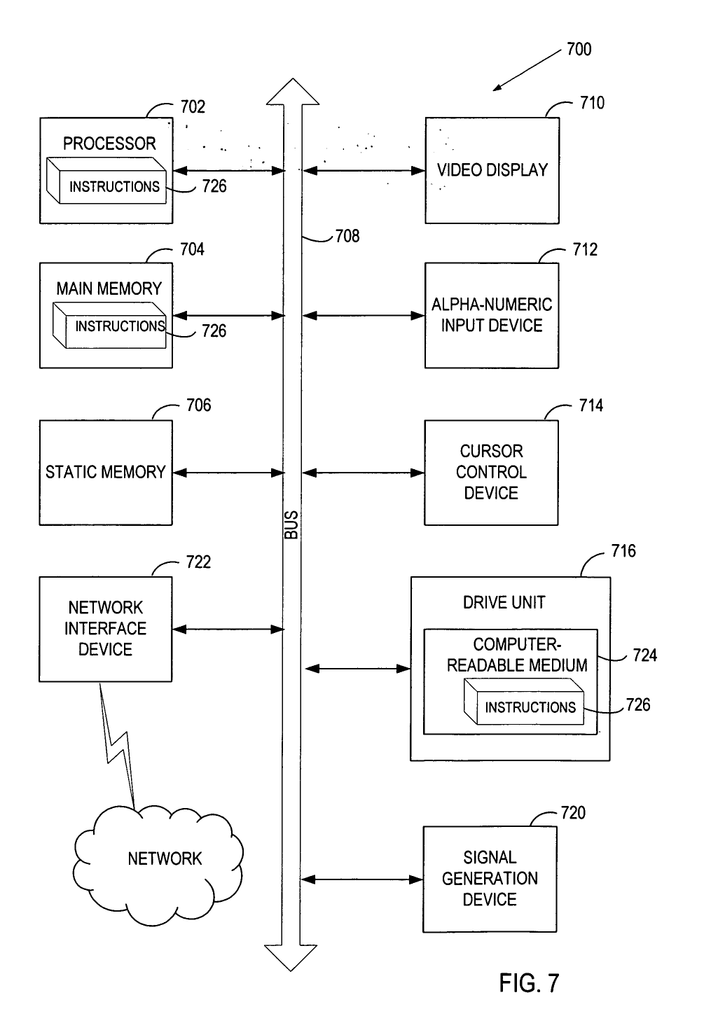

FIG. 7 is a block diagram of an exemplary computer system 700 that may be used to perform one or more of the operations described herein. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine. The computer system 700 includes a processor 702, a main memory 704 and a static memory 706, which communicate with each other via a buss 708. The computer system 700 may further include a video display unit 710 (e.g., a liquid crystal display (LCD) or a cathode ray tube (CRT)). The computer system 700 also includes an alpha-numeric input device 712 (e.g., a keyboard), a cursor control device 714 (e.g., a mouse), a disk drive unit 716, a signal generation device 720 (e.g., a speaker) and a network interface device 722. The disk drive unit 716 includes a computer-readable medium 724 on which is stored a set of instructions (i.e., software) 726 embodying any one, or all, of the methodologies described above. The software 726 is shown to reside, completely or at least partially, within the main memory 704 and/or within the processor 702. The software 726 may further be transmitted or received via the network interface device 722. For the purposes of this specification, the term “computer-readable medium” shall be taken to include any medium that is capable of storing or encoding a sequence of instructions for execution by the computer and that cause the computer to perform any one of the methodologies of the present invention. The term “computer-readable medium” shall accordingly be taken to include, but not be limited to, solid-state memories, optical and magnetic disks, and carrier wave signals.

Method and apparatus for constructing semantic descriptions using transform technology has been described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

The terminology used in this application with respect to MPEG-7 is meant to include all environments that provide content descriptions. Therefore, it is manifestly intended that this invention be limited only by the following claims and equivalents thereof.

1. A computerized method comprising:
blending a plurality of existing descriptions to create a new description;
extracting a residue from each of the plurality of existing descriptions; and
creating a set of image style pyramids for the new description using residues extracted from the plurality of existing descriptions.

2. The computerized method of claim 1 wherein each of the plurality of existing descriptions is a semantic description scheme.

3. The computerized method of claim 1 wherein each of the plurality of existing descriptions is represented as a graph.

4. The computerized method of claim 3 wherein the plurality of existing descriptions is blended using a graph transformation operation.

5. The computerized method of claim 4 wherein the graph transformation operation is a pushout operation.

6. The computerized method of claim 4 wherein blending the plurality of existing descriptions comprises:
creating a blend of each pair of the plurality of existing descriptions; and
blending each pair of created blends.

7. The computerized method of claim 6 further comprising:
creating a generic space for each pair of the plurality of existing descriptions.

8. The computerized method of claim 7 wherein the set of pyramids is created using residues, blends and generic spaces created for the plurality of of existing descriptions.

9. The computerized method of claim 7 wherein the graph transformation operation is a pullback operation.

10. The computerized method of claim 7 wherein extracting the residue for each of the plurality of existing descriptions comprises:
determining the difference between each of the plurality of existing descriptions and a corresponding generic space.

11. The computerized method of claim 1 wherein the set of image style pyramids comprises a wavelet pyramid, a Laplacian pyramid, and a Gaussian pyramid.

12. The method of claim 1 further comprising:
transmitting the set of image style pyramids of the new description to a client.

13. The computerized method of claim 1 further comprising:
storing the set of image style pyramids in a database.

14. The computerized method of claim 1 further comprising:
using the set of image style pyramids to analyze the new description.

15. A computer readable medium that provides instructions, which when executed on a processor cause the processor to perform a method comprising:
blending a plurality of existing descriptions to create a new description;
extracting a residue from each of the plurality of existing descriptions; and
creating a set of image style pyramids for the new description using residues extracted from the plurality of existing descriptions.

16. The computer-readable medium of claim 15 wherein each of the plurality of existing descriptions is a semantic description scheme.

17. The computer-readable medium of claim 15 wherein each of the plurality of existing descriptions is represented as a graph.

18. The computer-readable medium of claim 17 wherein the plurality of existing descriptions is blended using a graph transformation operation.

19. A computerized system comprising:
a memory; and
at least on processor coupled to the memory, the processor executing a set of instructions which cause the processor to blend a plurality of existing descriptions to create a new description, extract a residue from each of the plurality of existing descriptions, and create a set of image style pyramids for the new description using residues extracted from the plurality of existing descriptions.

20. The computerized system of claim 19 wherein each of the plurality of existing descriptions is a semantic description scheme.

21. The computerized system of claim 19 wherein each of the plurality of existing descriptions is represented as a graph.

22. The computerized system of claim 21 wherein the plurality of existing descriptions is blended using a graph transformation operation.

23. A computerized system comprising:
a memory; and
at least on processor coupled to the memory, the processor executing a set of instructions which cause the processor to encode a plurality of existing image descriptions as a wavelet transform comprising a set of new image descriptions, the wavelet transform being subsequently used to decode the plurality of existing image descriptions.

24. The computerized system of claim 23 wherein the plurality of existing image descriptions is decoded from the wavelet transform in a lossless fashion.

25. The computerized system of claim 23 wherein the plurality of existing image descriptions is decoded from the wavelet transform in a lossy fashion.

26. An apparatus comprising:
means for blending a plurality of existing descriptions to create a new description;
means for extracting a residue from each of the plurality of existing descriptions; and
means for creating a set of image style pyramids for the new description using residues extracted from the plurality of existing descriptions.
